(19) United States
(12) Patent Application Publication
(10) Pub. No.: US 2004/0112064 A1
(43) Pub. Date: Jun. 17, 2004

(54) Gas turbine with device for extracting work from disk cooling air

(76) Inventors: Winfried-Hagen Friedl, Berlin (DE); Joerg Au, Berlin (DE)

Correspondence Address: Davidson Berquist, Klima & Jackson LLP, Suite 920, 4501 North Fairfax Drive, Arlington, VA, 22203, US

(21) Appl. No.: 10/668,119

(22) Filed: Sep. 23, 2003

(30) Foreign Application Priority Data
Sep. 23, 2002 (DE) 102 44 192.8

(51) Int. Cl. F02C 7/12

(52) U.S. Cl. 60/806

(57) ABSTRACT

A gas turbine includes at least one compressor 1 and at least one turbine 2, wherein one portion of the air leaving the compressor 1 is delivered to a combustion chamber 3 and a further portion is extracted as cooling air, wherein at least one portion of the cooling air flow 4 is directed through a secondary air turbine 5, for extracting energy.

This application claims priority to German Patent Application DE10244192.8 filed Sep. 23, 2002, the entirety of which is incorporated by reference herein.

### FIELD OF THE INVENTION

The invention relates to a gas turbine having a device for extracting work from disk cooling air.

In particular, the invention relates to a gas turbine having at least one compressor and at least one turbine, wherein one portion of the air leaving the compressor is delivered to a combustion chamber and a further portion is extracted as cooling air.

### BACKGROUND OF THE INVENTION

In gas turbines, the disk of the first high-pressure turbine stage in particular is tempered or cooled with air from two different compressor stages. The edge of the disk, together with the turbine blades and often also with the diaphragm, is always cooled with air leaving the compressor. The hub of the disk is cooled with air from a lower compressor stage, which is often furnished by a vortex reducer.

The increasing power concentration in the core drive mechanism of a gas turbine progressively increases the compressor outlet temperature and thus also the temperatures of those parts that come into contact with the air at that outlet.

To keep the resultant thermal stresses within acceptable limits, the temperature conditions with the disk must not exceed a certain amount. To a certain extent, this can be assured by suitable tempering of the disk hub, namely by raising the temperature of the air supplied.

The prior art describes possible ways of lowering the temperature of the compressor outlet air by means of an additional cooler. To compensate for the resultant unwanted pressure loss in the cooler, small compressor blade systems below the combustion chamber are provided in stationary gas turbines and raise the pressure of the cooling air upstream of the cooler.

In summary, in the prior art, the following disadvantages and problem areas occur: the hotter the cooling air that is extracted from the compressor, the more air that is needed to cool the blades, and hence the more the disks are heated by the hot cooling air. The resultant loss in strength of the disks and blades can be compensated for to a certain extent by using materials capable of withstanding higher thermal loads, or by thickening the material. The disadvantage, however, is particularly the higher production costs.

The higher cooling air consumption and the fact that the disks are heavier for the reasons given above mean poor specific fuel consumption. The result is a shorter range of an aircraft and increased fuel costs. Furthermore, the greater weight and higher production costs prove to be highly disadvantageous.

For suitable tempering of the cooling air that bathes the disk hub, the cooling air is passed through a heavy vortex reducer. This cooling air is furthermore additionally used to seal off the rear storage chamber. Increasing the temperature of the cooling air leads to increased oil deposits on the heated walls of the storage chamber and an increased risk of oil fires.

### SUMMARY OF THE INVENTION

One object of the invention is to create a gas turbine of the type defined at the outset which is simple in design, safe and reliable in operation, favorable in terms of production costs, and low in weight and makes efficient cooling of the high-pressure turbine stage possible while overcoming the disadvantages of the prior art.

According to the invention, the object is attained by the combination of characteristics disclosed herein with further advantageous features of the invention being described below.

According to the invention, it is thus provided that at least a portion of the cooling air flow is carried through a secondary air turbine, for extracting energy.

The gas turbine of the invention is distinguished by a number of major advantages.

By means of the secondary air turbine of the invention, energy is extracted from the cool air leaving the compressor before this air reaches the high-pressure turbine disks. The cooling air is thus cooled down highly effectively. At the same time, the extracted energy can be used to increase the power of the gas turbine, since the secondary air turbine is mounted on the shaft of the gas turbine.

It is especially advantageous according to the invention that complex, expensive additional cooling devices, such as the coolers known from the prior art, can be dispensed with.

Dispensing with such coolers not only reduces the costs but also decreases the complexity of the gas turbine, since additional lines or the like are not needed, either. There are also advantages in terms of the total weight.

One substantial advantage of the invention is also that the cooling air temperature is already lowered in the front side of the high-pressure turbine disks, and the thermal load in this region is thus reduced. As a further effect, the air for hub cooling can have a low temperature, without inducing major thermal stresses in the disk. Because of the lesser thermal load, the weight of the disk can thus be reduced.

It is also advantageous that together with new production methods for the disk, more-economical materials can be used for the diaphragm regions and hub regions of the disk.

In contrast to the prior art, the cooling air generates power as energy is extracted from it. This increases the efficiency of the gas turbine and reduces fuel consumption.

Reducing the temperature of the hub cooling air increases the security against oil fires. Moreover, because of the lower temperatures, it is possible for the rear bearing chamber to be made simpler in structure and in this way to reduce both the weight and costs.

In an especially favorable feature of the invention, it is provided that the rotor of the secondary air turbine is secured to the high-pressure shaft of the gas turbine. As a result, as already noted, the possibility arises of delivering the power of the secondary air turbine directly to the gas turbine power. A structurally simple embodiment is also possible.

Preferably, the secondary air turbine is disposed below the inner housing of the combustion chamber. Thus the space available in this region can be utilized without having to increase the overall dimensions of the gas turbine.

The secondary air turbine of the invention can be embodied either as a single-stage turbine or as a 1½-stage turbine. Overall, the most versatile possible structural ways of attaining the object are achieved.

The rotor blading system of the secondary air turbine can be embodied integrally with a component of the high-pressure shaft. Alternatively, it is also possible to embody it as a separate component and connect it to the high-pressure shaft. The same is true for the guide blading system of the secondary air turbine, which can be embodied as either integral with a component of the housing or as a separate component.

The invention is described below in terms of an exemplary embodiment in conjunction with the drawings wherein like reference numerals indicate like components.

### BRIEF DESCRIPTION OF THE DRAWINGS

FIG. 1, shows a schematic side view in section of a gas turbine of the invention with a secondary air turbine of the invention; and

FIG. 2, shows an enlarged side view in section of the arrangement of FIG. 1

### DETAILED DESCRIPTION OF THE PREFERRED EMBODIMENT

The detailed description following should be read in conjunction with the summary of the invention above.

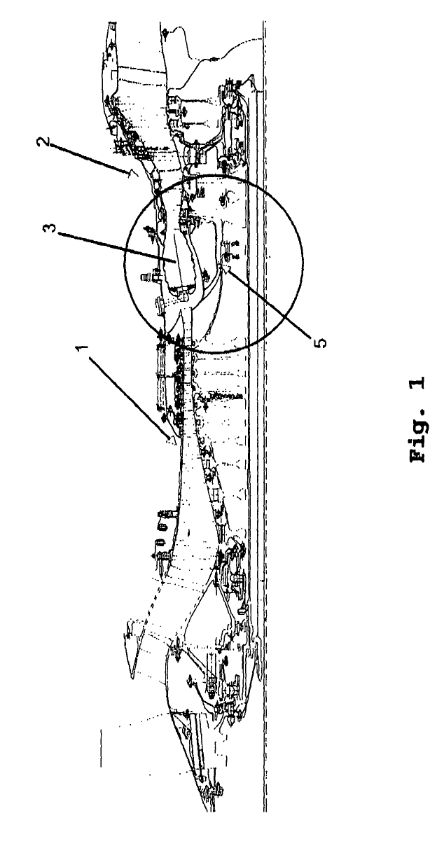

FIG. 1 shows a schematic sectional view of a gas turbine of the invention. This gas turbine includes a compressor 1 and a turbine 2. An annular combustion chamber 3 is also provided. A more-detailed description of these components can be dispensed with at this point, since they are known from the prior art.

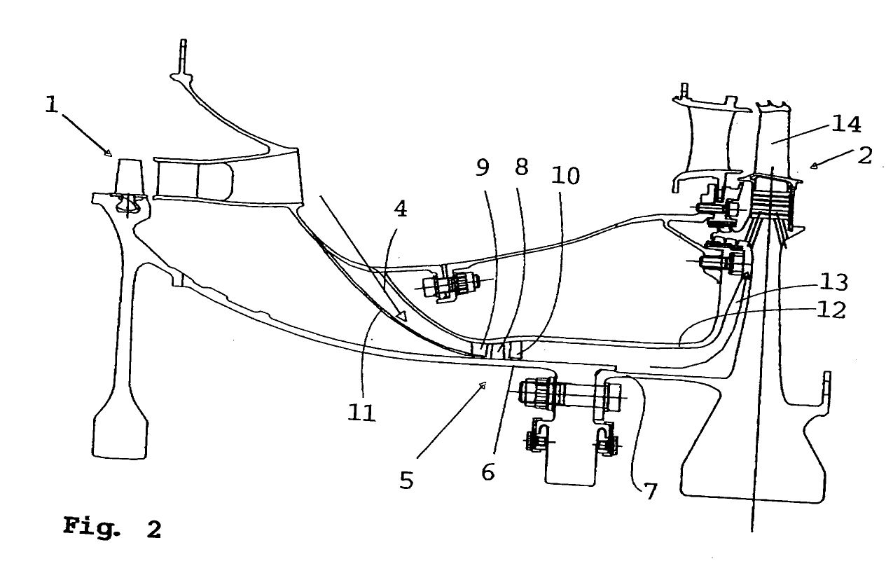

FIG. 2 shows an enlarged view (of the detail enclosed in the circle in FIG. 1) of a secondary air turbine 5 of the invention. This turbine is disposed below the inner housing of the combustion chamber 3. A cooling air flow 4 is delivered to it via a channel 11. This cooling air flow meets a guide blading system 9 of the secondary air turbine 5. The secondary air turbine 5 is provided with a rotor blading system 8, which is secured to a rotor 6. The exemplary embodiment shown involves a 1½-stage secondary air turbine 5, which includes a further guide blading system 10, which like the guide blading system 9 is secured to a housing 12. The rotor 6 is part of a rotor shaft 7, shown only in part and schematically.

After leaving the secondary air turbine 5, the cooling air is carried, among other places, to a turbine blade 14 of the turbine 2, via a channel 13 shown only schematically.

The invention is not limited to the exemplary embodiment shown; on the contrary, other modifications are possible within the scope of the invention. These have to do in particular to the disposition and embodiment of the secondary air turbine and the air passages and seals or the like required for it, as is also schematically shown in FIG. 2.

What is claimed is:

1. A gas turbine comprising at least one compressor and at least one turbine, wherein one portion of air leaving the compressor is delivered to a combustion chamber and a further portion is extracted as cooling air, and further comprising a secondary air turbine, wherein at least one portion of the cooling air flow is directed through the secondary air turbine, in order to lower the temperature of the cooling air.

2. The gas turbine of claim 1, wherein a rotor of the secondary air turbine is secured to a high-pressure shaft of the gas turbine.

3. The gas turbine of claim 1, wherein the secondary air turbine is disposed below an inner housing of the combustion chamber.

4. The gas turbine of claim 3, wherein the secondary air turbine is embodied as a single-stage turbine.

5. The gas turbine of claim 4, wherein a rotor blading system of the secondary air turbine is embodied integrally with a component of the high-pressure shaft.

6. The gas turbine of claim 4, wherein a rotor blading system of the secondary air turbine is embodied as a separate component and is connected to the high-pressure shaft.

7. The gas turbine of claim 4, wherein a guide blading system of the secondary air turbine is embodied integrally with a component of the housing.

8. The gas turbine of claim 4, wherein a guide blading system of the secondary air turbine is embodied as a separate component and is connected to the housing.

9. The gas turbine of claim 3, wherein the secondary air turbine is embodied as a 1½-stage turbine.

10. The gas turbine of claim 9, wherein a rotor blading system of the secondary air turbine is embodied integrally with a component of the high-pressure shaft.

11. The gas turbine of claim 9, wherein a rotor blading system of the secondary air turbine is embodied as a separate component and is connected to the high-pressure shaft.

12. The gas turbine of claim 9, wherein a guide blading system of the secondary air turbine is embodied integrally with a component of the housing.

13. The gas turbine of claim 9, wherein a guide blading system of the secondary air turbine is embodied as a separate component and is connected to the housing.

14. The gas turbine of claim 1, wherein the secondary air turbine is embodied as a single-stage turbine.

15. The gas turbine of claim 1, wherein a rotor blading system of the secondary air turbine is embodied integrally with a component of the high-pressure shaft.

16. The gas turbine of claim 1, wherein a rotor blading system of the secondary air turbine is embodied as a separate component and is connected to the high-pressure shaft.

17. The gas turbine of claim 1, wherein a guide blading system of the secondary air turbine is embodied integrally with a component of the housing.

18. The gas turbine of claim 1, wherein a guide blading system of the secondary air turbine is embodied as a separate component and is connected to the housing.

19. The gas turbine of claim 1, wherein the secondary air turbine is embodied as a 1½-stage turbine.
